(19) United States
(12) Patent Application Publication
(10) Pub. No.: US 2005/0057464 A1
(43) Pub. Date: Mar. 17, 2005

(54) Method of driving a liquid crystal display device

(76) Inventors: Ching-Tung Wang, Chunan (TW); Chih-Kuang Lin, Chunan (TW); Fu-Chih Chang, Chunan (TW)

Correspondence Address: RABIN & CHAMPAGNE, P.C.;Suite 500, 1101 14 Street, N.W., Washington, DC, 20005, US

(21) Appl. No.: 10/661,502

(22) Filed: Sep. 15, 2003

(51) Int. Cl. G09G 3/36

(52) U.S. Cl. 345/87

(57) ABSTRACT

A method for driving a liquid crystal display device is disclosed. When data clock (DCLK) is not required, the method of driving a liquid crystal display device with low power consumption enables the close loop of the DCLK. That is, after a data transmission (LOAD) signal is triggered and before a data reception (DSTH) signal is triggered, the timing controller forces the DCLK signal to be at a low voltage level, which means the DCLK signal is not outputted, and therefore power saving is achieved.

### BACKGROUND OF THE INVENTION

1. Field of Invention

The present invention relates to a method of driving a liquid crystal display device, and more particularly to a method of driving a liquid crystal display device with low power consumption.

2. Related Art

A liquid crystal display device usually includes a pair of parallel glass substrates between which is provided the assembly at least of an indium tin oxide (ITO) film, an alignment film and a color filter. The slot directions of the alignment films are perpendicular to each other. A liquid crystal material is placed between the substrates along the slots of the alignment film. When an electric field is applied between the substrates, the liquid crystal molecules become vertical to the slots so that light cannot pass and consequently black color is shown on the display screen. Therefore, a display can be implemented through controlling the liquid crystal molecules according to the variation of the electric field.

FIG. 1 shows a driver circuit of a conventional liquid crystal display device. A driver circuit 100 includes a timing controller 110 and a source driver 120. The source driver 120 receives TTL data 302 from the timing controller 110 and accordingly generates an analog signal 303 for controlling a liquid crystal display panel 200. The timing controller 110 converts an image data into a digital image signal 302 and outputs the digital image signal 302. The timing controller 110 further outputs a control signal 301 that is a polarity-inverting signal for controlling the polarity of an analog voltage outputted from the source driver 120.

The number of color scales is an important factor that influences the display quality.

The greater the number of color scales is, the higher power is needed. Although power consumption is not the most serious concern for a liquid crystal display device of a desktop computer, it may be critical for a small display device of a portable electronic device such as a cell phone, a personal digital assistant or a laptop computer.

Therefore, there is a need of a display device with low power consumption suitable for use in a portable electronic device.

### SUMMARY OF THE INVENTION

An object of the invention is to provide a method of driving a liquid crystal display device with low power consumption.

In the liquid crystal display device driving method of the invention, power saving is achieved by reducing unnecessary power consumption, rather than by changing the construction of the driver circuit.

In order to achieve the above and other objectives, when the data clock (DCLK) is not required, a method of driving a liquid crystal display device with low power consumption according to the invention enables a close loop of the driving circuit.

That is, after a data transmission signal (hereinafter, referred as to LOAD) is triggered and before a data reception signal (hereinafter, referred as to DSTH) is triggered, the timing controller forces the DCLK signal to be at a low voltage level, which means the DCLK signal is not outputted, and therefore power saving is achieved.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given in the illustration below only. Such illustrations are not meant to be limitative of the present invention:

FIG. 1 is block diagram of a driver circuit of a conventional liquid crystal display device;

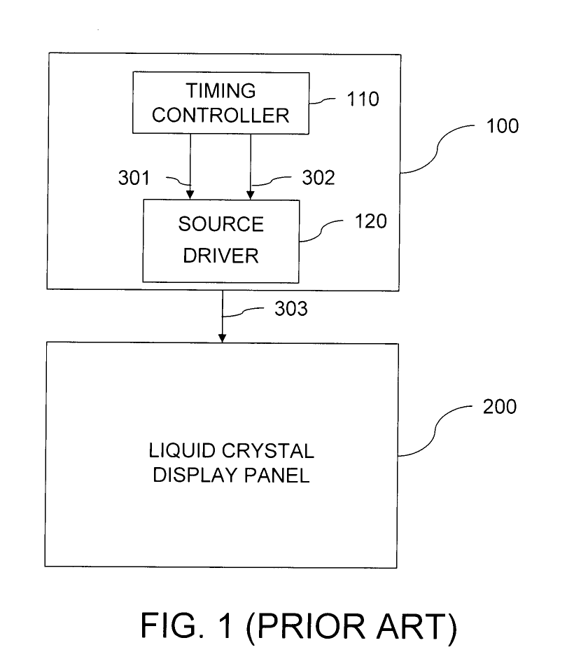

FIG. 2 is a time sequence diagram of data programming/control of a driver circuit of a conventional liquid crystal display device;

FIG. 3 is a time sequence diagram of data programming/control of a driver circuit of a liquid crystal display device according to one embodiment of the invention; and

FIG. 4 is a flow chart of data programming/control of a driver circuit of a liquid crystal display device according to one embodiment of the invention.

### DETAILED DESCRIPTION OF THE INVENTION

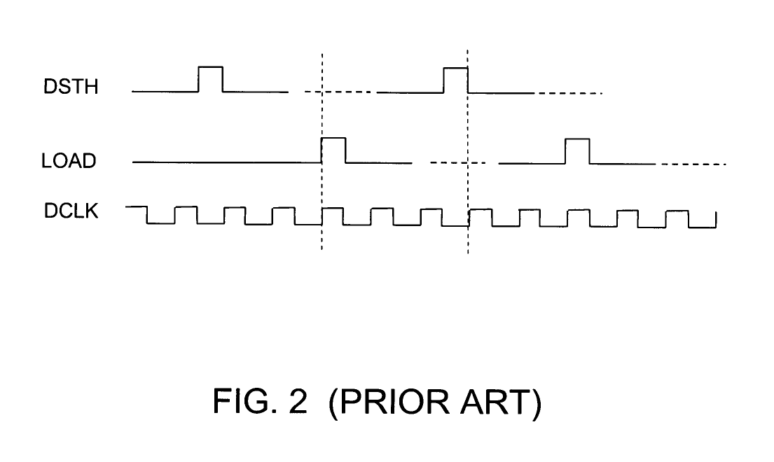

FIG. 2 illustrates a data input performed in a conventional liquid crystal display device. A DSTH signal determines the programming time of a timing controller. A LOAD signal confirms the programming time of the data into the display panel. While the LOAD signal is switched on and the DSTH signal is not switched on the timing controller is not energized. At this time, a clock signal (DCLK) is still transmitted, which wastes the electrical current.

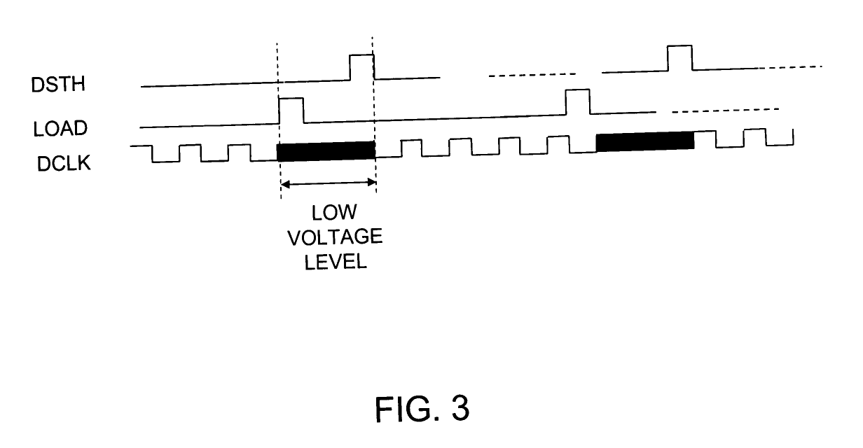

FIG. 3 illustrates a data input performed by a method of driving a liquid crystal display device with low power consumption according to the invention. While performing a high voltage level of the LOAD signal to a low voltage level of the DSTH signal the DCLK signal is forced to be at a low voltage level by the timing controller.

A driver circuit of a liquid crystal display device according to the invention includes a timing controller and a source driver. The timing controller receives an image data and outputs a digital image signal. The source driver receives the digital image signal and generates an analog image signal.

The DSTH signal controls the data input to the timing controller. The LOAD signal controls the data input to the display panel. When the DSTH signal is at low voltage level, the data are inputted to the driver circuit until the DSTH signal turns to a high voltage level. When the LOAD signal is at high voltage level, the data are inputted to the display panel until the DSTH signal turns to a low voltage level. In other words, the data input to the display panel is performed while a peak of the LOAD signal to a peak of the DSTH signal is performed. Within this period, the DCLK signal is set to be at low voltage level to reduce power consumption.

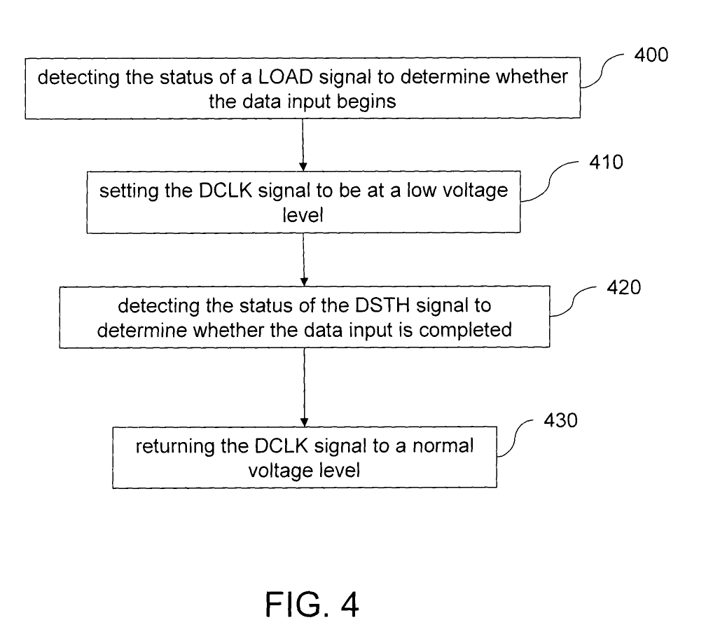

FIG. 4 is a flow chart of a data input to the driver circuit of a liquid crystal display device according to one embodiment of the invention. The timing controller detects the status of the LOAD signal to determine whether the data input begins (Step 400). When the LOAD signal is at a high voltage level, it means there are some data to be inputted in the display panel. At this time, the DCLK signal is forced to be at a low voltage level (Step 410). Meanwhile, the DSTH signal is detected to determine whether data input is completed (Step 420). When the DSTH signal is at a high voltage level, it means that data input is completed. At this time, the DCLK signal returns to its normal voltage level (Step 430).

It is noted that the LOAD signal is enabled at high voltage level. Forcing the DCLK signal at a low voltage level begins when the LOAD signal suddenly rises to or drops from a high voltage level. The DSTH signal is enabled at a high voltage level. Forcing the DCLK signal at low voltage level ends when the DSTH signal suddenly rises to or drops from a high voltage level.

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method of driving a liquid crystal display device, the liquid crystal display device comprising driver circuit, which comprises a timing controller driven by a data transmission signal (LOAD signal)and a source driver driven by a data reception signal (DSTH signal), the method comprising the steps of:
detecting a status of the LOAD signal; and
controlling a DCLK signal according to the status of the LOAD signal.

2. A method of driving a liquid crystal display device, the liquid crystal display device comprising a driver circuit, which comprises a timing controller driven by a data transmission signal (LOAD signal)and a source driver driven by a data reception signal (DSTH signal), the method being characterized in that:
within the period from the time when the data transmission signal (LOAD signal) is enabled to the time when the data reception signal (DSTH signal) is enabled, a data clock (DCLK signal) is forced to be at a low voltage level.

3. The method of claim 2, wherein the LOAD signal is enabled at a high voltage level.

4. The method of claim 3, wherein forcing the DCLK signal to be at a low voltage level begins at the rising edge of the LOAD signal when being as a high voltage level.

5. The method of claim 3, wherein forcing the DCLK signal to be at a low voltage level begins at the falling edge of the LOAD signal when being as a high voltage level.

6. The method of claim 2, wherein the DSTH signal is enabled at a high voltage level.

7. The method of claim 6, wherein forcing the DCLK signal to be at a low voltage level ends at the falling edge of the DSTH signal when being as a high voltage level.

8. The method of claim 6, wherein forcing the DCLK signal to be at a low voltage level ends at the rising edge of the DSTH signal when being as a high voltage level.

9. A method of driving a liquid crystal display device, the liquid crystal display device comprising driver circuit, which comprises a timing controller driven by a data transmission signal (LOAD signal)and a source driver drived by a data reception signal (DSTH signal), the method comprising the steps of:
detecting the status of the LOAD signal to determine whether the data input begins;
forcing a DCLK signal to be at a low voltage level when the LOAD signal is at a high voltage level;
detecting the status of the DSTH signal to determine whether the data input is completed; and
returning the DCLK signal to be at a normal voltage level when the DSTH signal is detected.

10. The method of claim 9, wherein the LOAD signal is enabled at a high voltage level.

11. The method of claim 10, wherein forcing the DCLK signal to be at a low voltage level begins at the rising edge of the LOAD signal when being as a high voltage level.

12. The method of claim 10, wherein forcing the DCLK signal to be at a low voltage level begins at the failing edge of the LOAD signal when being as a high voltage level.

13. The method of claim 9, wherein the DSTH signal is enabled at a high voltage level.

14. The method of claim 13, wherein forcing the DCLK signal to be at a low voltage level ends at the falling edge of the DSTH signal when being as a high voltage level.

15. The method of claim 13, wherein forcing the DCLK signal to be at a low voltage level ends at the rising edge of the DSTH signal when being as a high voltage level.
